(19) United States
(12) Patent Application Publication
(10) Pub. No.: US 2014/0022706 A1
(43) Pub. Date: Jan. 23, 2014

(54) ELECTRIC CONDUCTIVE POLYMER AQUEOUS SUSPENSION AND METHOD FOR PRODUCING THE SAME, ELECTRIC CONDUCTIVE ORGANIC MATERIAL, AND SOLID ELECTROLYTIC CAPACITOR AND METHOD FOR PRODUCING THE SAME

(71) Applicants: Yasuhisa Sugawara, Miyagi (JP); Tomoki Nobuta, Miyagi (JP); Yuji Yoshida, Miyagi (JP); Satoshi Suzuki, Miyagi (JP); Yasuhiro Tomioka, Miyagi (JP)

(72) Inventors: Yasuhisa Sugawara, Miyagi (JP); Tomoki Nobuta, Miyagi (JP); Yuji Yoshida, Miyagi (JP); Satoshi Suzuki, Miyagi (JP); Yasuhiro Tomioka, Miyagi (JP)

(21) Appl. No.: 14/110,085

(22) PCT Filed: Apr. 9, 2012
(86) PCT No.: PCT/JP2012/059692

§ 371 Date: Oct. 4, 2013

(30) Foreign Application Priority Data
Apr. 8, 2011 (JP) 2011-086364

(51) Int. Cl. H01G 9/028; H01G 9/00

(52) U.S. Cl. CPC H01G 9/028; H01G 9/0036
USPC 361/527; 252/62.2; 427/80

(57) ABSTRACT

An electric conductive polymer aqueous suspension is prepared by dispersing an electric conductive polymer powder whose surface is doped with a polyacid in which the number of anion groups is 50% or more and 99% or less with respect to the number of repeating units of the polyacid. By using the electric conductive polymer aqueous suspension, an organic material excellent in adhesiveness to a substrate and humidity resistance, and high in conductivity, as well as a solid electrolytic capacitor low in ESR and excellent in reliability in a high humidity atmosphere, and a method for producing the same can be provided.

### TECHNICAL FIELD

The present invention relates to an electric conductive polymer aqueous suspension and a method for producing the same, a conductive organic material obtained from the electric conductive polymer aqueous suspension, and a solid electrolytic capacitor using the conductive organic material and a method for producing the same.

### BACKGROUND ART

Electric conductive polymer materials are used for electrodes of capacitors, electrodes of dye-sensitized solar cells, electrodes of electroluminescence displays. As such electric conductive polymer materials, polymer materials obtained by polymerizing a monomer(s) such as pyrrole, thiophene, 3,4-ethylenedioxy thiophene, aniline are known.

JP2010-40776A as Patent Literature 1 discloses a method for producing an electric conductive polymer aqueous suspension, comparing preforming chemical oxidative polymerization of a monomer for providing an electric conductive polymer by an oxidant in a solvent containing a dopant including a low molecular organic acid or a salt thereof to synthesize an electric conductive polymer; purifying the electric conductive polymer, and then mixing the electric conductive polymer with the oxidant in an aqueous solvent containing a polyacid component. Patent Literature 1 further discloses a method for producing an electric conductive polymer material that is obtained by removing the solvent from the electric conductive polymer aqueous suspension.

### REFERENCE LIST

### Patent Literature

Patent Literature 1: JP2010-40776A

### SUMMARY OF INVENTION

### Technical Problems to be Solved by the Invention

In Patent Literature 1, the electric conductive polymer aqueous suspension is produced by using a polyacid in which the number of anion groups is 100% with respect to the number of repeating units of the polyacid. However, an electric conductive polymer material obtained from such an electric conductive polymer aqueous suspension is high in hygroscopic property because most of anion groups serving as hydrophilic groups are in a free state, by which the electric conductive polymer is not doped.

In general, if an electric conductive polymer material with a high hygroscopic property or a composite thereof is used as an electrode material, the electrode can swell or shrink due to the change in ambient humidity, resulting in deterioration in adhesiveness to a substrate. Therefore, the electrode material using such an electric conductive polymer material or composite thereof has been problematic in terms of reliability under a high humidity atmosphere.

Thus, an object of the present invention is to provide an electric conductive polymer aqueous suspension from an organic polymer material, which is excellent in humidity resistance and high in conductivity; and a method for producing the electric conductive polymer aqueous suspension, by suppressing the hygroscopic property of the electric conductive polymer material.

Furthermore, another object of the present invention is to provide a solid electrolytic capacitor, which is excellent in adhesiveness to a substrate, low in equivalent series resistance (hereinafter, ESR) and excellent in reliability in a high humidity atmosphere; and a method of producing the solid electrolytic capacitor.

### Means for Solving the Problems

In order to achieve the above objects, the present invention is characterized in an electric conductive polymer aqueous suspension formed by dispersing an electric conductive polymer powder whose surface is doped with a polyacid, wherein the number of anion groups of the polyacid is 50% or more and 99% or less with respect to the number of repeating units of the polyacid.

In addition, in the electric conductive polymer aqueous suspension according to the present invention, the anion group of the polyacid is preferably a sulfo group.

In addition, in the electric conductive polymer aqueous suspension according to the present invention, the electric conductive polymer powder is preferably a powder that comprises a polymer obtained from pyrrole, thiophene, aniline, or a derivative thereof, and that is doped with an organic acid.

Herein, the organic acid is preferably at least one selected from benzenesulfonic acid, naphthalenesulfonic acid, camphorsulfonic acid, derivatives thereof and salts thereof.

The electric conductive polymer powder is a powder including a polymer obtained from pyrrole, thiophene, aniline, or a derivative thereof. The electric conductive polymer powder is preferably doped with an organic acid.

In addition, a method for producing an electric conductive polymer aqueous suspension according to the present invention characterized in comprising:

a first step of performing chemical oxidative polymerization of pyrrole, thiophene, aniline, or a derivative thereof by using an oxidant in water, an organic solvent or a water-mixed organic solvent containing an organic acid or a salt thereof as a dopant to provide a mixture containing an electric conductive polymer powder;

a second step of removing an impurity(ies) from the mixture to recover the electric conductive polymer powder; and

a third step of allowing an oxidant to act on the electric conductive polymer in an aqueous solvent containing a polyacid, wherein the number of anion groups of the polyacid is 50% or more and 99% or less with respect to the number of repeating units of the polyacid.

In addition, in the third step, a polyacid in which the anion group of the polyacid is a sulfo group is preferably used.

In addition, an electric conductive organic material according to the present invention is characterized in that the electric conductive organic material is formed by drying the electric conductive polymer aqueous suspension, in which the number of anion groups of the polyacid is 50% or more and 99% or less with respect to the number of repeating units of the polyacid, to remove the solvent.

In addition, a solid electrolytic capacitor according to the present invention is characterized in comprising an anode conductor including a valve metal, a dielectric layer formed on the surface of the anode conductor, and an electrolyte layer containing the conductive organic material on the dielectric layer.

In addition, in a first aspect of a method for producing a solid electrolytic capacitor according to the present invention, the method is characterized in comprising:

a step of forming a dielectric layer on the surface of an anode conductor including a valve metal;

a step of coating or impregnating the dielectric layer with the electric conductive polymer aqueous suspension; and

a step of removing the solvent of the electric conductive polymer aqueous suspension to form an electrolyte layer.

In addition, in a second aspect of a method for producing a solid electrolytic capacitor according to the present invention, the method is characterized in comprising:

a step of forming a dielectric layer on the surface of an anode conductor including a valve metal;

a step of performing chemical oxidative polymerization or electropolymerization of a monomer for providing an electric conductive polymer compound to form a first electrolyte layer on the dielectric layer;

a step of coating or impregnating the first electrolyte layer with the electric conductive polymer aqueous suspension; and

a step of removing the solvent of the electric conductive polymer aqueous suspension to form a second electrolyte layer.

In addition, in the second aspect of a method for producing a solid electrolytic capacitor according to the present invention, the method preferably comprises a step of performing chemical oxidative polymerization or electropolymerization of at least one selected from pyrrole, thiophene, aniline, and derivatives thereof to thereby form a first electrolyte layer on the dielectric layer.

### Effects of the Invention

According to the present invention, an electric conductive polymer aqueous suspension for providing an organic material excellent in humidity resistance and high in conductivity is obtained. A solid electrolytic capacitor is also obtained, which is excellent in adhesiveness to a substrate, low in ESR and excellent in reliability in a high humidity atmosphere.

### BRIEF DESCRIPTION OF DRAWINGS

FIG. 1 is a schematic view illustrating a form of an electric conductive polymer powder dispersed in an electric conductive polymer aqueous suspension according to the present invention.

FIG. 2 is a cross-sectional view schematically illustrating a structure of a solid electrolytic capacitor according to the present invention.

### DESCRIPTION OF EMBODIMENTS

Hereinafter, an electric conductive polymer aqueous suspension and a method for producing the same, a conductive organic material obtained from the aqueous suspension, and an electrolytic capacitor using the conductive organic material and a method for producing the same, according to the present invention, will be described in detail.

(Electric Conductive Polymer Aqueous Suspension)

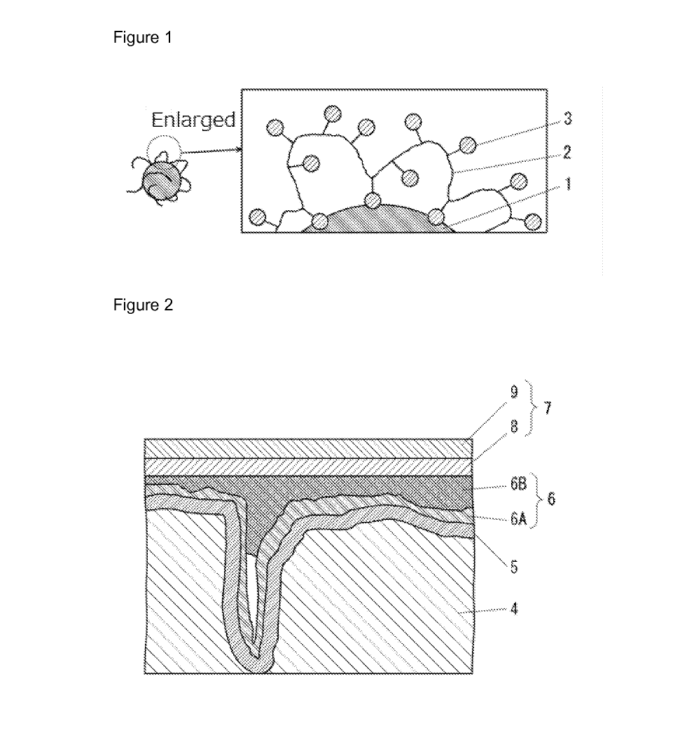

FIG. 1 is a schematic view illustrating a form of an electric conductive polymer powder dispersed in an aqueous liquid suspension of an electric conductive polymer according to the present invention. In FIG. 1, an electric conductive polymer powder 1, namely, a particle comprising an electric conductive polymer is provided in a structure, in which polyacids 2 are coordinated and stabilized on the surface of the electric conductive polymer powder 1. The surface of the electric conductive polymer powder 1 is doped with some of anion groups 3 of the polyacids 2. Thus, the anion groups of the polyacids are, in part, physically bound, to the surfaces of the electric conductive polymer particles (powder), wherein the polyacids are provided as a dopant of the electric conductive polymer on the surfaces of the electric conductive polymer particles (powder).

The electric conductive polymer aqueous suspension according to the present invention comprises the electric conductive polymer powder on which the polyacid is bound to the surface, and a solvent containing water as a main component, in which the electric conductive polymer powder is contained in the state of being dispersed in the solvent. The number of anion groups of the polyacid is preferably 50% or more and 99% or less and more preferably 60% or more and 90% or less with respect to the number of repeating units of the polyacid. Herein, the electric conductive polymer aqueous suspension means one in which its solvent contains water in an amount of 50% or more.

In the case where the number of anion groups of the polyacid exceeds 99% with respect to the number of repeating units of the polyacid, the anion group in a free state without doping is excessively present. Since a hygroscopic property of a conductive organic material depends on the number of free anion groups with which the electric conductive polymer powder is not doped, the hygroscopic property of the conductive organic material obtained from the electric conductive polymer aqueous suspension becomes higher.

In addition, in the case where the number of anion groups of the polyacid is less than 50% with respect to the number of repeating units of the polyacid, the number of anion groups with which the electric conductive polymer powder is doped is reduced, and thus a polymer aqueous suspension with a desirable conductivity is not obtained. Furthermore, the number of free anion groups is also reduced, which are present in the surface of the electric conductive polymer powder to contribute to dispersing in the solvent containing water as a main component. Therefore; the electric conductive polymer powder is dispersed not easily in the solvent containing water as a main component.

In general, the hygroscopic property of the conductive organic material depends on the number of anion groups, with which the electric conductive polymer powder is not doped. The number of anion groups, with which the electric conductive polymer powder is not doped, depends on the ratio of the number of anion groups to the number of repeating units of the polyacid. Accordingly, the ratio of the number of anion groups to the number of repeating units of the polyacid can be changed to thereby control the hygroscopic property of the conductive organic material.

For controlling the proportion of the anion group of the polyacid, a known method can be adopted. Examples include:

a method, in which a ratio between a monomer carrying an anion group and a monomer carrying no anion group is adjusted to perform polymerization of the monomer; and

a method, in which the amount of a reactant for substitution of the anion group (in the case of sulfonating, the reactant is a sulfonating agent such as fuming sulfuric acid) and the reaction time to the polymer main chain having no anion group are adjusted, in order to produce the polyacid from the polymer having no anion group.

In the polyacid for use in preparing the electric conductive polymer aqueous suspension according to the present invention, the number of anion groups of the polyacid is 50% or more and 99% or less with respect to the number of repeating units of the polyacid. Therefore, the number of free anion groups, by which the electric conductive polymer powder is not doped, is suppressed to provide an electric conductive organic material excellent in humidity resistance.

The polyacid can include polycarboxylic acids such as polyacrylic acid, polymethacrylic acid and polymaleic acid, polysulfonic acids such as polyvinyl sulfonic acid and polystyrene sulfonic acid, and copolymers including a repeating unit including at least one of monomers capable of forming these polysulfonic acids. A polystyrene sulfonic acid including repeating units represented by the following formulae 1a and 1b is particularly preferable. The proportion of the repeating unit bearing an anion group such as a sulfo group represented by the chemical formula 1a in the repeating unit of the polyacid is 50% or more and 99% or less. Any one of such polyacids may be selected and used, or a combination of two or more thereof may be used.

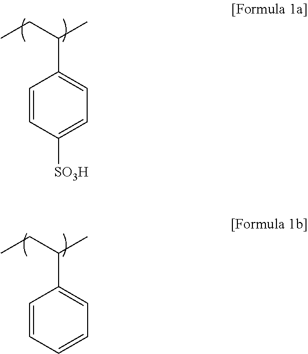

The weight average molecular weight of the polyacid is preferably 2,000 to 500,000 and more preferably 10,000 to 200,000.

The content of the polyacid in the electric conductive polymer aqueous suspension according to the present invention is preferably 20 to 3,000 parts by weight and more preferably 30 to 1,000 parts by weight with respect to 100 parts by weight of the electric conductive polymer powder.

Examples of the electric conductive polymer contained in the electric conductive polymer aqueous suspension according to the present invention include polypyrrole, polythiophene, polyaniline, and derivatives thereof. Poly(3,4-ethylenedioxy thiophene) or a derivative thereof including a repeating unit represented by the following formula 2 is particularly preferable. The electric conductive polymer may be a homopolymer or a copolymer, and any one of such electric conductive polymers may be selected and used, or a combination of two or more thereof may be used.

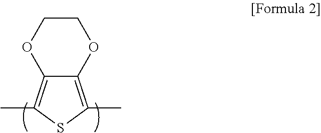

The content of the electric conductive polymer in the electric conductive polymer aqueous suspension according to the present invention is preferably 0.1 to 30 parts by weight and more preferably 0.5 to 20 parts by weight with respect to 100 parts by weight of water as a solvent.

The particle size of the electric conductive polymer powder is desirably φ1 μm or less and more desirably φ500 nm or less.

(Method for Producing Electric Conductive Polymer Aqueous Suspension)

The electric conductive polymer aqueous suspension according to the present invention is obtained by the following steps.

(First Step)

In a first step, in order to obtain a mixture containing an electric conductive polymer powder, chemical oxidative polymerization of a monomer for providing an electric conductive polymer is performed by using an oxidant in a solvent containing an organic acid or a salt thereof as a dopant. Herein, a solvent composition with high compatibility with the monomer that is lipophilic can be selected as desired.

Examples of the dopant include alkyl sulfonic acid, benzenesulfonic acid, naphthalenesulfonic acid, anthraquinone sulfonic acid, camphorsulfonic acid, and their derivatives and their salts with iron (III) having a function as the dopant. Such sulfonic acids may be each a monosulfonic acid, disulfonic acid or trisulfonic acid. Among them, a monosulfonic acid is selected as the dopant to thereby provide an electric conductive polymer with a high degree of polymerization and a high degree of crystallization.

Examples of the derivative of the alkyl sulfonic acid include 2-acrylamide-2-methylpropanesulfonic acid. Examples of the derivative of the benzenesulfonic acid include phenolsulfonic acid, styrenesulfonic acid, toluenesulfonic acid, and dodecylbenzenesulfonic acid. Examples of the derivative of the naphthalenesulfonic acid include 1-naphthalenesulfonic acid, 2-naphthalenesulfonic acid, 1,3-naphthalenedisulfonic acid, 1,3,6-naphthalenetrisulfonic acid, and 6-ethyl-1-naphthalenesulfonic acid. Examples of the derivative of the anthraquinone sulfonic acid include anthraquinone-1-sulfonic acid, anthraquinone-2-sulfonic acid, anthraquinone-2,6-disulfonic acid, and 2-methylanthraquinone-6-sulfonic acid. Among them, 1-naphthalenesulfonic acid, 2-naphthalenesulfonic acid, 1,3,6-naphthalenetrisulfonic acid, anthraquinone disulfonic acid, p-toluenesulfonic acid, camphorsulfonic acid, or an iron (III) salt thereof is preferable. Any one of the above exemplified dopants may be selected and used, or a combination of two or more thereof may be used.

The amount of the dopant used is not particularly limited because the dopant can be removed in a second step described below even if being excess. The amount of the dopant used is preferably 1 to 100 parts by weight and more preferably 1 to 50 parts by weight with respect to 1 part by weight of the monomer.

As the solvent, any of water, an organic solvent, and a water-mixed organic solvent may be used, but a solvent good in compatibility with the monomer is preferably selected. Furthermore, a solvent good in compatibility with also the dopant and the oxidant is particularly preferably selected. Examples of the organic solvent include alcohol solvents such as methanol, ethanol and propanol, and low-polarity solvents such as acetonitrile and acetone. Any one of such organic solvents may be selected and used, or a combination of two or more thereof may be used. Ethanol, or a mixed solvent of ethanol and water is particularly preferable.

The monomer for providing an electric conductive polymer may be selected depending on the objective electric conductive polymer. Any one of such monomers may be selected and used, or a combination of two or more thereof may be used.

The concentration of the monomer in the solvent for chemical oxidative polymerization is preferably 0.1 to 50% by weight and more preferably 0.5 to 30% by weight.

Polypyrrole and a derivative thereof are obtained by polymerizing the corresponding pyrrole or a derivative of the pyrrole. Examples of the derivative of the pyrrole include 3-alkylpyrroles such as 3-hexylpyrrole, 3,4-dialkylpyrroles such as 3,4-dihexylpyrrole, 3-alkoxypyrroles such as 3-methoxypyrrole, and 3,4-dimethoxypyrroles such as 3,4-dimethoxypyrrole.

Polythiophene and a derivative thereof are obtained by polymerizing the corresponding thiophene or a derivative of the thiophene. Examples of the derivative of the thiophene include 3,4-ethylenedioxy thiophene and a derivative thereof, 3-alkylthiophenes such as 3-hexylthiophene, and 3-alkoxythiophenes such as 3-methoxythiophene. Examples of the derivative of 3,4-ethylenedioxy thiophene include 3,4-(1-alkyl)ethylenedioxy thiophenes such as 3,4-(1-hexyl)ethylenedioxy thiophene.

Polyaniline and a derivative thereof are obtained by polymerizing the corresponding aniline or a derivative of the aniline. Examples of the derivative of the aniline include 2-alkylanilines such as 2-methylaniline, and 2-alkoxyanilines such as 2-methoxyaniline, but poly(3,4-ethylenedioxy thiophene) or a derivative thereof is particularly preferable.

The oxidant is not particularly limited as long as it can provide an electric conductive polymer powder as an object of the present invention. Examples of the oxidant that can be used include iron (III) salts of an inorganic acid such as iron (III) chloride hexahydrate, anhydrous iron (III) chloride, iron (III) nitrate nonahydrate, anhydrous ferric nitrate, iron (III) sulfate n-hydrate (n=3 to 12), ammonium iron (III) sulfate dodecahydrate, iron (III) perchlorate n-hydrate (n=1, 6) and iron (III) tetrafluoroborate; copper (II) salts of an inorganic acid such as copper (II) chloride, copper (II) sulfate and copper (II) tetrafluoroborate; nitrosonium tetrafluoroborate; persulfates such as ammonium persulfate, sodium persulfate and potassium persulfate; periodates such as potassium periodate; hydrogen peroxide, ozone, potassium hexacyanoferrate (III), tetraammonium cerium (IV) sulfate dihydrate, bromine and iodine; and iron (III) salts of an organic acid such as iron (III) p-toluenesulfonate. Among them, iron (III) salts of an inorganic acid or an organic acid, or persulfates are preferable. In addition, ammonium persulfate or iron (III) p-toluenesulfonate is more preferable, and iron (III) p-toluenesulfonate is furthermore preferable because of its property of doubling as the dopant. Any one of such oxidants may be selected and used, or a combination of two or more thereof may be used.

The amount of the oxidant used is not particularly limited because the dopant can be removed in a second step even if being excess. In order to obtain a polymer with a high conductivity by the reaction under a milder oxidation atmosphere, the amount of the oxidant added is preferably 0.5 to 100 parts by weight and more preferably 1 to 50 parts by weight with respect to 1 part by weight of the monomer.

The reaction temperature of the chemical oxidative polymerization is not particularly limited. The reaction temperature is generally about the reflux temperature of the solvent used, and is preferably 0 to 100° C. and more preferably 10 to 50° C. If the reaction temperature is not adequate, conductivity can be impaired. The reaction time of the chemical oxidative polymerization depends on the type and amount of the oxidant charged, the reaction temperature, the stirring condition, and the like, but is about 5 to 100 hours.

(Second Step)

In a second step, the dopant, the remaining unreacted monomer(s), and the remaining metal ion and anion derived from the oxidant are removed from the reaction liquid containing the electric conductive polymer obtained by the chemical oxidative polymerization. Examples of a method of washing the electric conductive polymer to separate it from the reaction liquid include a filtration method and a centrifugal method.

As the washing solvent, a solvent capable of dissolving the monomer and/or oxidant without dissolving the electric conductive polymer is preferably used. Examples of the washing solvent include water, and alcohol solvents such as methanol, ethanol and propanol. Any one of such washing solvents may be selected and used, or a combination of two or more thereof may be used. The degree of washing can be confirmed by measuring the pH of the washing solvent after the washing or by performing colorimetric observation.

Furthermore, the electric conductive polymer is preferably washed with hot water and/or is subjected to a heat treatment because a metal component derived from the oxidant can be removed at a higher level. The temperature of the heat treatment is not particularly limited as long as it is equal to or lower than the decomposition temperature of the electric conductive polymer. The heat treatment is preferably performed at 50° C. or higher and lower than 300° C. In addition, as a method for removing the metal ion and anion derived from the oxidant, an ion-exchange treatment using an ion-exchange resin is also efficiently performed.

An impurity contained in the electric conductive polymer can be quantitatively analyzed by ICP emission analysis or ion chromatography.

(Third Step)

A third step includes action of an oxidant on the electric conductive polymer powder recovered in the second step in an aqueous solution containing the polyacid. An electric conductive polymer aqueous suspension can be obtained, which has the good dispersibility of the electric conductive polymer powder, by action of the polyacid and the oxidant as dispersants of the electric conductive polymer powder on the electric conductive polymer powder.

As the polyacid, the above polycarboxylic acids and polysulfonic acids, and a copolymer provided with these repeating units can be used. Polystyrene sulfonic acid is particularly preferable. The polyacid is provided with a structure in which the proportion of the repeating unit carrying an anion group such as a sulfo group in the repeating unit of the polyacid is 50% or more and 99% or less. The weight average molecular weight of the polyacid is preferably 2,000 to 500,000 and more preferably 10,000 to 200,000.

The amount of the polyacid used is preferably 20 to 3,000 parts by weight and more preferably 30 to 1,000 parts by weight with respect to 100 parts by weight of the electric conductive polymer powder obtained in the second step.

As the oxidant, any of the oxidants exemplified in the first step can be used, but ammonium persulfate or hydrogen peroxide is particularly preferable.

The amount of the oxidant used is preferably 10 to 500 parts by weight and more preferably 50 to 300 parts by weight with respect to 100 parts by weight of the electric conductive polymer powder obtained in the second step.

As the solvent of the aqueous solution containing the polyacid, a solvent containing water as a main component can be used. A water-soluble organic solvent(s) may be further added thereto. Examples of the water-soluble organic solvents include alcohol solvents such as methanol, ethanol and propanol, and low-polarity solvents such as acetonitrile and acetone. Such water-soluble organic solvents can be used singly or in combinations of two or more.

The reaction temperature in the third step is not particularly limited. The reaction temperature is preferably 0 to 100° C. and more preferably 10 to 50° C. The reaction time is not particularly limited. For example, the reaction temperature is about 5 to 100 hours. In addition, the above-described ion-exchange treatment is preferably performed after the third step.

(Conductive Organic Material)

The electric conductive organic material according to the present invention is obtained by drying the electric conductive polymer aqueous suspension to remove the solvent. The drying temperature for removing the solvent is not particularly limited as long as it is equal to or lower than the decomposition temperature of the electric conductive polymer. The temperature is preferably a temperature that is 300° C. or lower and that exerts a drying effect.

(Electrolytic Capacitor and Method for Producing the Same)

The electrolytic capacitor according to the present invention includes an electrolyte layer containing the electrical conductive organic material. The electrolyte layer is preferably in the form of solid. The electrolytic capacitor according to the present invention is low in ESR because the conductivity of a material for forming an electrolyte is high. Furthermore, the material for forming an electrolyte is a polymer material with a high degree of crystallization, and the oxygen barrier property thereof is high correlating with the degree of crystallization. In addition, since the number of anion groups of the polyacid is suppressed to 50% or more and 99% or less with respect to the number of repeating units of the polyacid, the hygroscopic property of the electrolyte is suppressed. As a result, an electrolytic capacitor can be provided, which is excellent in adhesiveness to a substrate and humidity resistance, and high in reliability.

FIG. 2 is a cross-sectional view schematically illustrating a structure of a solid electrolytic capacitor according to the present invention. In FIG. 2, the solid electrolytic capacitor is provided with a structure in which a dielectric layer 5, a solid electrolyte layer 6 and a cathode conductor 7 are formed on an anode conductor 4 in this order.

The anode conductor 4 is formed of a plate, a foil or a wire of a valve metal, a sintered body including fine particles of a valve metal, a porous material of a valve metal subjected to an area enlargement treatment by etching. Examples of the valve metal include tantalum, aluminum, titanium, niobium, zirconium, and alloys of at least two of them. At least one valve metal selected from aluminum, tantalum and niobium is particularly preferably used.

The dielectric layer 5 is a layer formed by electrolytic oxidation of the surface of the anode conductor 4, and is also formed on pores of a sintered body, a porous body, or the like. The thickness of the dielectric layer 5 can be appropriately adjusted by the voltage of electrolytic oxidation.

The solid electrolyte layer 6 comprises at least the electric conductive organic material obtained from the electric conductive polymer aqueous suspension according to the present invention, in which the electric conductive polymer powder bound to the polyacid is dispersed. The solid electrolyte layer 6 may be provided with a monolayer structure or a multilayer structure. In the solid electrolytic capacitor illustrated in FIG. 2, the solid electrolyte layer 6 comprises a first electrolyte layer 6A and a second electrolyte layer 6B. A first electric conductive polymer contained in the first electrolyte layer 6A and a second electric conductive polymer contained in the second electrolyte layer 6B are preferably the same type of polymer.

Furthermore, the solid electrolyte layer 6 may contain at least one material selected from an electric conductive polymer obtained by polymerization of pyrrole, thiophene, aniline, or a derivative thereof; an oxide derivative such as manganese dioxide or ruthenium oxide; and an organic semiconductor such as a TCNQ (7,7,8,8-tetracyanoquinodimethane) complex salt.

Examples of a method for forming the solid electrolyte layer 6 as a monolayer include a method for coating or impregnating the dielectric layer 5 with the electric conductive polymer aqueous suspension in which the electric conductive polymer powder, to which the polyacid is bound, is dispersed, and removing the solvent from the electric conductive polymer aqueous suspension.

In addition, a solid electrolyte layer 6 including two layers in the solid electrolytic capacitor illustrated in FIG. 2 can be formed by a method for performing chemical oxidative polymerization or electropolymerization of a monomer for providing a first electric conductive polymer compound to form the first electrolyte layer 6A on the dielectric layer 5, coating or impregnating the first electrolyte layer 6A with the electric conductive polymer aqueous suspension in which the electric conductive polymer powder bound to the polyacid is dispersed, and drying the resultant to thereby form the second electrolyte layer 6B.

As the monomer for providing a first electric conductive polymer compound, at least one selected from pyrrole, thiophene, aniline, and derivatives thereof can be used, as described in the “first step” in producing an electric conductive polymer aqueous suspension according to the present invention. As the dopant for use upon chemical oxidative polymerization or electropolymerization of the monomer to obtain a first electric conductive polymer compound, sulfonic acid compounds such as benzenesulfonic acid, naphthalenesulfonic acid, phenolsulfonic acid, styrenesulfonic acid, and derivatives thereof are preferable. The molecular weight of the dopant that can be used is appropriately selected within the range from low molecular weight to high molecular weight. The solvent may be water, an organic solvent or a water-mixed organic solvent. Examples of the organic solvent include alcohol solvents such as methanol, ethanol and propanol; and low-polarity solvents such as acetonitrile and acetone.

The coating or impregnating method is not particularly limited. In order to allow the electric conductive polymer aqueous suspension to be sufficiently packed into porous pores, the electric conductive polymer aqueous suspension is preferably left to stand for several minutes to several ten minutes after the coating or impregnating. In addition, the method is preferably performed by repeating of immersing, or by using a pressure reduction system or a pressurization system.

The solvent of the electric conductive polymer aqueous suspension can be removed by drying a coating film of the electric conductive polymer aqueous suspension. The drying temperature is not particularly limited as long as it is a temperature that enables to remove the solvent. In order to prevent an element from being degraded by heat, the drying is preferably performed within the range of 80° C. or higher and less than 300° C. The dying time is required to be appropriately optimized depending on the drying temperature, but is not particularly limited as long as conductivity is not impaired.

The cathode conductor 7 is not particularly limited as long as it is a conductor. For example, the cathode conductor 7 can be provided as a two-layer structure including a carbon layer 8 such as graphite and a silver-conductive resin layer 9.

### EXAMPLES

### Example 1

Hereinafter, the present invention will be described in detail based on Examples, but the scope of the present invention is not intended to be limited only to these Examples.

(First Step)

A mixed liquid obtained by dissolving 3,4-ethylenedioxy thiophene (1 g) as a monomer and iron (III) p-toluenesulfonate (9 g) serving as an oxidant and a dopant in ethanol (30 ml) as a solvent was stirred under room temperature for 24 hours to perform oxidative polymerization of the monomer. During this, the color of the mixed liquid was changed from yellow to dark blue.

(Second Step)

The mixed liquid obtained in the first step was filtrated by a reduced-pressure filtration apparatus to recover a powder. The resulting powder was washed with pure water to remove excess amounts of the oxidant and dopant. The washing with pure water was repeatedly performed until the pH of the filtrate reached 6 to 7. After the pH of the filtrate reached 6 to 7, the filtrate was washed with ethanol to remove the monomer, the oxidant, and the oxidant after the reaction (iron (II) p-toluenesulfonate). The washing with ethanol was performed until the color of the filtrate was turned to be colorless and transparent.

(Third Step)

The powder (0.5 g) obtained in the second step was dispersed in water (50 ml), and then a 20% by weight aqueous solution containing polystyrene sulfonic acid as a polyacid (weight average molecular weight: 50,000) (3.3 g) was added thereto. Herein, the polystyrene sulfonic acid used was one in which the sulfo group number was 50% with respect to the number of repeating units of the polystyrene sulfonic acid. To the mixed liquid was further added ammonium persulfate (1.5 g) as an oxidant, and these were allowed to be stirred to react with each other under room temperature for 24 hours. The color of the resulting polythiophene aqueous suspension was dark blue.

(Evaluation of Electric Conductive Polymer Film)

The polythiophene aqueous suspension obtained in the third step was dropped on a glass substrate in an amount of 100 μl, and the solvent thereof was completely volatilized in a constant-temperature bath at 150° C. to form an electric conductive polymer film. The surface resistance (Ω/sq) and the thickness of the resulting electric conductive polymer film were measured by a four-terminal method to calculate conductivity (S/cm). In addition, the resulting electric conductive polymer film was left to stand in a constant temperature and humidity bath at a temperature of 65° C. and at a humidity of 95% for 24 hours, and then the amount of moisture in the electric conductive polymer film was measured by using a trace moisture measurement apparatus CA-200 model (Mitsubishi Chemical Analytech Co., Ltd.).

(Evaluation of Solid Electrolytic Capacitor)

Porous aluminum was used as an anode conductor comprising a valve metal, and an oxide film serving as a dielectric layer was formed on the surface of aluminum by anodic oxidation. An anode section and a cathode section were partitioned by an insulating resin. Then, the cathode section of the anode conductor, on which the dielectric layer was formed, was immersed in and pulled up from the resulting polythiophene aqueous suspension, and then dried and solidified in a constant-temperature bath at 125° C. to form a solid electrolyte layer. Then, a carbon layer and a silver-containing resin layer were sequentially formed on the solid electrolyte layer to prepare a solid electrolytic capacitor.

The equivalent series resistance (ESR) of the solid electrolytic capacitor at 100 kHz was measured by using E4980A Precision LCR Meter (Agilent Technologies). The measurement was performed immediately after the preparation and after the solid electrolytic capacitor was left to stand in a constant temperature and humidity bath at a temperature of 65° C. and at a humidity of 95% for 500 hours.

### Example 2

A polythiophene aqueous suspension was obtained in the same manner as in Example 1 except that, in the third step, a polystyrene sulfonic acid in which the sulfo group number was 60% with respect to the number of repeating units of the polystyrene sulfonic acid was used. Thereafter, an electric conductive polymer film was formed in the same manner as in Example 1, and the conductivity and the amount of moisture were evaluated. In addition, a solid electrolytic capacitor was prepared in the same manner as in Example 1, and the ESR was measured.

### Example 3

A polythiophene aqueous suspension was obtained in the same manner as in Example 1 except that, in the third step, a polystyrene sulfonic acid in which the sulfo group number was 80% with respect to the number of repeating units of the polystyrene sulfonic acid was used. Thereafter, an electric conductive polymer film was formed in the same manner as in Example 1, and the conductivity and the amount of moisture were evaluated. In addition, a solid electrolytic capacitor was prepared in the same manner as in Example 1, and the ESR was evaluated.

### Example 4

A polythiophene aqueous suspension was obtained in the same manner as in Example 1 except that, in the third step, a polystyrene sulfonic acid in which the sulfo group number was 90% with respect to the number of repeating units of the polystyrene sulfonic acid was used. Thereafter, an electric conductive polymer film was formed in the same manner as in Example 1, and the conductivity and the amount of moisture were evaluated. In addition, a solid electrolytic capacitor was prepared in the same manner as in Example 1, and the ESR was evaluated.

### Example 5

A polythiophene aqueous suspension was obtained in the same manner as in Example 1 except that, in the third step, a polystyrene sulfonic acid in which the sulfo group number was 99% with respect to the number of repeating units of polystyrene sulfonic acid was used. Thereafter, an electric conductive polymer film was formed in the same manner as in Example 1, and the conductivity and the amount of moisture were evaluated. In addition, a solid electrolytic capacitor was prepared in the same manner as in Example 1, and the ESR was evaluated.

### Comparative Example

A polythiophene aqueous suspension was obtained in the same manner as in Example 1 except that, in the third step, a polystyrene sulfonic acid in which the sulfo group number was 100% with respect to the number of repeating units of the polystyrene sulfonic acid was used. Thereafter, an electric conductive polymer film was formed in the same manner as in Example 1, and the conductivity and the amount of moisture were evaluated. In addition, a solid electrolytic capacitor was prepared in the same manner as in Example 1, and the ESR was evaluated.

TABLE 1

| | | | | Evaluation results of solid | |
|---|---|---|---|---|---|
| | Ratio | | | electrolytic capacitor | |
| | of anion | | | ESR (mΩ · cm²) | |
| | group | Evaluation results of | | | After leaving |
| | number to | electric conductive | | | to stand in |
| | repeating | polymer film | | | constant |
| | unit | Con- | | | temperature |
| | number of | duc- | Amount of | Immediately | and humidity |
| | polyacid | tivity | moisture | after | bath for 500 |
| | (%) | (S/cm) | (%) | preparation | hours |
| Example 1 | 50 | 340 | 5 | 1.9 | 2.8 |
| Example 2 | 60 | 395 | 7 | 1.6 | 2.5 |
| Example 3 | 80 | 400 | 8 | 1.5 | 2.3 |
| Example 4 | 90 | 390 | 10 | 1.5 | 2.4 |
| Example 5 | 99 | 405 | 11 | 1.5 | 2.9 |
| Com- | 100 | 390 | 13 | 1.5 | 3.2 |
| parative | | | | | |
| Example | | | | | |

Table 1 shows the evaluation results of the electric conductive polymer films and the solid electrolytic capacitors. The ESR value was normalized from that of the total cathode section area to that of the unit area (1 cm²). As shown in Table 1, the amount of moisture in each of the electric conductive polymer films obtained in Examples 1 to 5 was smaller than that in the electric conductive polymer film obtained in Comparative Example, after each film was left to stand in a constant temperature and humidity bath at a temperature of 65° C. and at a humidity of 95% for 24 hours. In addition, the ESR of each of the solid electrolytic capacitors obtained in Examples 1 to 5 was lower than that of the solid electrolytic capacitor obtained in Comparative Example, after each capacitor was left to stand in a constant temperature and humidity bath at a temperature of 65° C. and at a humidity of 95% for 500 hours. From these results, it is found that the electric conductive polymer film and the solid electrolytic capacitor according to the present invention are excellent in humidity resistance.

The above effects could be obtained for the following reasons:

The number of anion groups of the polyacid coordinated on the surface of the electric conductive polymer powder is in the range of 50% or more and 99% or less with respect to the number of repeating units of the polyacid. As a result, the number of anion groups in a free state involved in hygroscopic property, by which the electric conductive polymer is not doped, is suppressed. Thus, the hygroscopic property of the electric conductive polymer obtained from the electric conductive polymer aqueous suspension is reduced.

Since the hygroscopic property of the electric conductive polymer is reduced, it is possible to suppress the swelling of the electric conductive polymer under a high humidity, and to suppress deterioration in adhesiveness to a substrate. Therefore, the electric conductive polymer according to the present invention is used to provide a solid electrolytic capacitor excellent in reliability, particularly excellent in reliability in a high humidity atmosphere.

### REFERENCE SIGNS LIST

1 electric conductive polymer powder
2 polyacid
3 anion group
4 anode conductor
5 dielectric layer
6 solid electrolyte layer
6A first electrolyte layer
6B second electrolyte layer
7 cathode conductor
8 carbon layer
9 silver-conductive resin layer

1. An electric conductive polymer aqueous suspension formed by dispersing an electric conductive polymer powder whose surface is doped with a polyacid, wherein the number of anion groups of the polyacid is 50% or more and 99% or less with respect to the number of repeating units of the polyacid.

2. The electric conductive polymer aqueous suspension according to claim 1, wherein the anion group of the polyacid is a sulfo group.

3. The electric conductive polymer aqueous suspension according to claim 1, wherein the electric conductive polymer powder is a powder comprising a polymer of pyrrole, thiophene, aniline, or a derivative thereof, and the electric conductive polymer powder is doped with an organic acid.

4. The electric conductive polymer aqueous suspension according to claim 3, wherein the organic acid is at least one selected from benzenesulfonic acid, naphthalenesulfonic acid, camphorsulfonic acid, derivatives thereof and salts thereof.

5. A method for producing an electric conductive polymer aqueous suspension, comprising:
a first step of performing chemical oxidative polymerization of pyrrole, thiophene, aniline, or a derivative thereof by using an oxidant in water, an organic solvent or a water-mixed organic solvent containing an organic acid or a salt thereof as a dopant to provide a mixture containing an electric conductive polymer powder;
a second step of removing an impurity from the mixture to recover the electric conductive polymer powder; and
a third step of allowing an oxidant to act on the electric conductive polymer in an aqueous solvent containing a polyacid, wherein the number of anion groups of the polyacid is 50% or more and 99% or less with respect to the number of repeating units of the polyacid.

6. The method for producing an electric conductive polymer aqueous suspension according to claim 5, wherein, in the third step, a polyacid in which the anion group of the polyacid is a sulfo group is used.

7. An electric conductive polymer aqueous suspension obtained by the method according to claim 5.

8. An electric conductive organic material formed by drying the electric conductive polymer aqueous suspension according to claim 1.

9. A solid electrolytic capacitor comprising an electrolyte layer containing the conductive organic material according to claim 8.

10. The solid electrolytic capacitor according to claim 9, comprising an anode conductor including a valve metal, and a dielectric layer formed on the surface of the anode conductor, wherein an electrolyte layer containing the conductive organic material according to claim 8 is formed on the dielectric layer.

11. A method for producing a solid electrolytic capacitor, comprising:
a step of forming a dielectric layer on the surface of an anode conductor including a valve metal; and
a step of coating or impregnating the dielectric layer with the electric conductive polymer aqueous suspension according to claim 1, and then removing the solvent to form an electrolyte layer.

12. A method for producing a solid electrolytic capacitor, comprising:
a step of forming a dielectric layer on the surface of an anode conductor including a valve metal;
a step of performing chemical oxidative polymerization or electropolymerization of a monomer for providing an electric conductive polymer compound to form a first electrolyte layer on the dielectric layer; and
a step of coating or impregnating the first electrolyte layer with the electric conductive polymer aqueous suspension according to claim 1, and then removing the solvent to form a second electrolyte layer.

13. The method for producing a solid electrolytic capacitor according to claim 12, wherein the monomer for providing an electric conductive polymer compound is at least one selected from pyrrole, thiophene, aniline, and derivatives thereof.
